(19) United States
(12) Patent Application Publication
(10) Pub. No.: US 2008/0256944 A1
(43) Pub. Date: Oct. 23, 2008

(54) Adiabatic D1D3 Isochoric D3 D2 Isothermal D2 D1

(76) Inventor: Benjamin Haneckow, Plainwell, MI (US)

Correspondence Address: Ben Haneckow, 11597 Breezy Point, Plainwell, MI, 49080, US

(21) Appl. No.: 12/080,970

(22) Filed: Apr. 8, 2008

Related U.S. Application Data
(60) Provisional application No. 60/922,641, filed on Apr. 10, 2007.

(51) Int. Cl. F03B 17/02

(52) U.S. Cl. 60/496

(57) ABSTRACT

Method will provide a way to move an object—bellows—into a liquid, object—bellows—will experience a sum of buoyancy as it move into liquid. Object—bellows—will then experience a new different sum of buoyancy as it move out of liquid. Change in sum of buoyancy can be result of taking energy from move into liquid phase putting energy into move out of liquid phase. This change in sum of buoyancy can be used in any way useful, especially to produce, generate, energy. Method can be employed on large scale or small scale; I will suggest example of method but there are infinite, many ways to produce different buoyancy sum.

I claim the benefit of Provisional Patent Application 60/922,641 Haneckow Power Plant Energy Method filed Apr. 10, 2007.

### COMPONENTS

Method includes a force 10, which can be gravity. A medium 20 which can be air (oxygen, nitrogen, . . . ). A medium 30, which can be water. A Bellows 40. Bellows 40 can contain medium 20 and be submerged into medium 30. Bellows can change size as pressure change around it, from change in depth in medium 30, change in size as pressure change area of medium 20. Bellows 40 can be a expansion chamber that contain medium 30 and; expand as pressure from medium 20 decrease, shrink as pressure from medium 20 increase. A device to move 50. Move 50 can be a object of weight qualities to submerge bellows 40 into medium 30. Move 50 can be a object of floating qualities to surface bellows 40. A device to make useful 60. Useful 60 can be any machine or means to make different sum of buoyancy useful. A bellows control 42. Bellows control 42 can cause bellows 40 to change size. Bellows 42 can cause bellows 40 not to change size. Bellows 40 can be a elastomer, or any device capable of changing size under pressure. A guide 70. Guide 70 can be any device that moves components where they are supposed to go.

Bellows control 42 can be a heat engine, adiabatic device, isochoric device, or isothermal device. Bellows control 42 can be a device to transfer heat. Bellows control 42 can be heat. Bellows control 42 can take heat from buoyancy sum moving into medium 20 to buoyancy sum moving out of medium 20.

### How to Make and Use

Arrange components in way that bellows 40 obtain different sum of buoyancy as it move out of medium 30 than it experience as it move into medium 30. Apply different sum of buoyancy to useful 60 to be used.

### EXAMPLE 1

This example gas is held isothermally and is to demonstrate buoyancy generator. Take a 20 cubic foot bellows 40, medium 20 inside bellows 40 can have psi around 15; like the air we breath. Submerge bellows 40 to around 20 feet deep with device to move 50, then use bellows control 42 to stop bellows 40 from shrinking. Bellows 40 is now at around 25 psi; 15 from air from surface 9 from psi from depth in water. Bellows 40 can now have size of 12.5 cubic feet. Now move bellows 40 to around 100 feet deep with move 50; while holding size with bellows control 42. Now add up sum of buoyancy from sinking action to this point. Maybe like

$$\frac{20 cubic feet}{15 + ( x times .45 )} [ 0 , 20 ] plus \frac{20 cubic feet}{15 + ( 20 times .45 )} times 100 minus 20$$

now use bellows control 42 to change size of bellows, internally; compress 6.25 cubic feet of bellows to 2.5 cubic feet. So you have bellows 40 with a section 10 cubic feet big (and around 15 psi) and a section 2.5 cubic feet big (and around 60 psi). Now make bellows control 42 hold size of 10 cubic foot side and allow 2.5 cubic foot side to adjust with pressure of outside medium 30. Allow move 50 to bring back to surface. Add up buoyancy from floating, surfacing action. Maybe like

$$\frac{10 cubic feet}{15 + ( x times .45 )} [ 100 , 0 ] plus \frac{10 cubic feet}{15} times 100$$

compare sum of buoyancy of sinking action to surfacing action and take account subtract energy required by bellows control 42. In this example sum of surfacing action is greater than sinking action.

This example gas is held isothermally and is to demonstrate buoyancy generator.

### EXAMPLE 2

Bellows 40 can be submerged adiabatically from start depth 1 to maximum depth 3. Then heat inside bellows can be withdrawn by bellows control 42. Bellows control 42 can hold bellows 40 at constant volume. Bellows 40 can surface at constant volume isochoric until it reach a depth 2 where pressure of medium 20 equal pressure inside bellows 40. At this depth bellows 40 can surface isothermally, as volume of bellows 40 increase and therefore temperature in bellows decreasing, taking heat from medium 20. Summary; move adiabatically from D1 to D3, heat temperature above medium 20 temperature withdrawn, move isochoric from D3 to D2, move isothermal from D2 to D1 taking heat from medium 20. Use heat withdrawn to enact method.

Bellows 40 can be submerged a depth adiabatically, then heat withdrawn, then submerged deeper, then heat withdrawn; process can be repeated until bellows is at maximum depth 3. Bellows control 42 can hold bellows 40 at constant volume. Bellows 40 can surface at constant volume isochoric until it reach a depth 2 where pressure of medium 20 equal pressure inside bellows 40. At this depth bellows 40 can surface isothermally, as volume of bellows 40 increase and therefore temperature in bellows decreasing, taking heat from medium 20.

Heat from Bellows 40 as it sink can be transferred into bellows 40 as it float.

Heat from bellows 40 can be converter to energy to enact method or other use.

Bellows 40 can be removed from medium 20 and kinetic energy of medium 20 descending across area previously held by bellows 40 used.

I claim:

1. A buoyancy generator of which, energy required by sinking plus energy produced by sinking, less than energy produced by floating, attached to device to make useful. A buoyancy generator that sink compress adiabatically and remove heat from adiabatic compression, that float at constant volume in depth where pressure of liquid medium greater than pressure of bellows medium, that allowed to float with increasing volume and intake heat energy from medium, that use heat removed, method then attached to device to make useful.
